(19) United States
(12) Patent Application Publication
(10) Pub. No.: US 2014/0229449 A1
(43) Pub. Date: Aug. 14, 2014

(54) REALTIME IDENTIFICATION OF CONTEXT MISMATCH

(71) Applicants: Abu Shaher Sanaullah, Austin, TX (US); James Webster Clardy, Austin, TX (US); Claude Lano Cox, Austin, TX (US); William B. Quinn, Austin, TX (US); Rocco Ancona, Austin, TX (US); Roy W. Stedman, Austin, TX (US)

(72) Inventors: Abu Shaher Sanaullah, Austin, TX (US); James Webster Clardy, Austin, TX (US); Claude Lano Cox, Austin, TX (US); William B. Quinn, Austin, TX (US); Rocco Ancona, Austin, TX (US); Roy W. Stedman, Austin, TX (US)

(21) Appl. No.: 13/764,466

(22) Filed: Feb. 11, 2013

(51) Int. Cl. G06F 17/30

(52) U.S. Cl. CPC G06F 17/30303
USPC 707/690

(57) ABSTRACT

Systems and method for realtime identification of a context mismatch are disclosed. The method may include determining a context mismatch based at least on an environmental context and a personal context, wherein the environmental context and the personal context are associated with a first user of the event, generating a plurality of event management options for managing the context mismatch, presenting the plurality of event management options to the user, and communicating a chosen option to a plurality of users of the event, the chosen option being one of the plurality of event management options.

### TECHNICAL FIELD

This invention relates generally to the field of information handling systems and more specifically to realtime and/or near-realtime identification of a context mismatch in managing an event.

### BACKGROUND

As the value and use of information continues to increase, individuals and businesses seek additional ways to process and store information. One option available to users is information handling systems (“information handling systems”). An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

As the ubiquity of information handling systems increases, so does the interaction and dependence on the activities of one user impact the activities of other users. However, traditional barriers remain for maintaining the integrity of realtime collaboration. One or more individuals may have roadblocks to participation that need to be managed.

### SUMMARY OF THE DISCLOSURE

In accordance with certain embodiments of the present disclosure, systems and methods for realtime identification of a context mismatch are disclosed. The systems and methods may include determining a context mismatch based at least on an environmental context and a personal context, wherein the environmental context and the personal context are associated with a first user of the event, generating a plurality of event management options for managing the context mismatch, presenting the plurality of event management options to the user, and communicating a chosen option to a plurality of users of the event, the chosen option being one of the plurality of event management options.

### BRIEF DESCRIPTION OF THE DRAWINGS

For a more complete understanding of the present invention and its advantages, reference is now made to the following description, taken in conjunction with the accompanying drawings, in which:

FIG. 1 illustrates an example system 100 for realtime and/or near-realtime identification of a context mismatch associated with a trigger event, in accordance with certain embodiments of the present disclosure; and

FIG. 2 illustrates a flowchart of an example method 200 for realtime and/or near-realtime identification of a context mismatch, in accordance with certain embodiments of the present disclosure.

### DETAILED DESCRIPTION OF THE INVENTION

For the purposes of this disclosure, an information handling system (“information handling system”) may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system (“IHS”) may include memory, one or more processing resources, such as a central processing unit (CPU) or hardware or software control logic. Additional components or the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

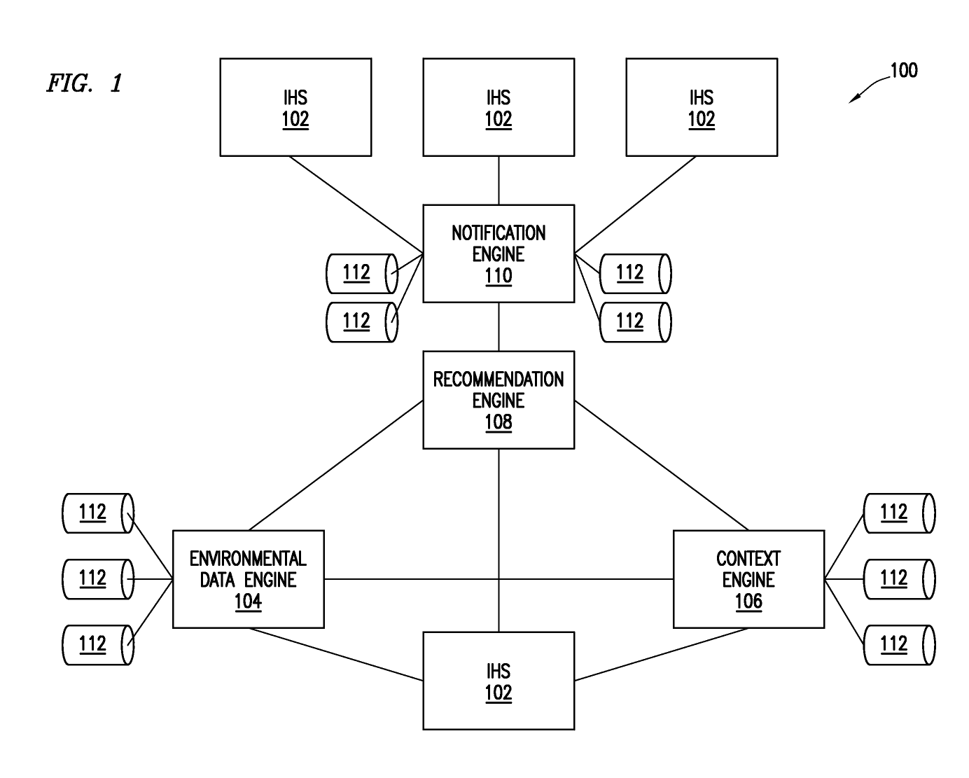

FIG. 1 illustrates an example system 100 for realtime and/or near-realtime identification of a context mismatch associated with a trigger event, in accordance with certain embodiments of the present disclosure. In some embodiments, the trigger event may be generally described as any event for which it may be appropriate to determine whether a context mismatch exists for a particular user associated with the trigger event. For example, a trigger event may include a meeting scheduled for a plurality of users, a project managing the efforts of a plurality of users, and/or any other appropriate trigger event.

In some embodiments, system 100 may include a plurality of information handling systems 102 communicatively coupled to notification engine 110. In some embodiments, one or more of the plurality of information handling systems 100 may be communicatively coupled to environmental data engine 104, context engine 106, and/or recommendation engine 108. In some embodiments, each of environmental data engine 104, context engine 106, and/or recommendation engine 108 may be further communicatively coupled to one or more data source(s) 112.

In some embodiments, the components of example system 100 may be communicatively coupled via any appropriate communications network. For example, the components of example system 100 may be configured to communicate via ethernet, cellular, and/or other appropriate communication network. In the same or alternative embodiments, components of example system 100 may be configured to communicate with one another via different communication networks. For example, recommendation engine 108 may be configured to communicate with one or more data source(s) 112 via a local area network (e.g., over ethernet) while information handling system 102 may be configured to communicate with recommendation engine 108 via a wide area network (e.g., over a cellular data network).

In some embodiments, environmental data engine may be configured to analyze data from one or more data source(s) 112 in order to provide environmental data to one or more information handling systems 102. For example, environmental data engine 104 may be configured to access data from a plurality of data sources 112 corresponding to transportation data, traffic data, and/or social data.

In the example system 100 depicted in FIG. 1, environmental data engine 104 may be communicatively coupled to three data sources 112. In some embodiments, environmental data engine 104 may be communicatively coupled to more, fewer, and/or different data sources 112 than those illustrated in FIG. 1 without departing from the scope of the present disclosure.

Further, for ease of illustration, environmental data engine 104 is depicted as communicatively coupled to separate data sources 112. In some embodiments, environmental data engine 104 may be part of an integral information handling system along with one or more data source(s) 112 as well as other components of system 100 without departing from the scope of the present disclosure. In the same or alternative embodiments, one or more data source(s) 112 may be hosted remotely on one or more information handling system(s), hosted locally by one or more information handling system(s), and/or may be the result of aggregating, analyzing, compiling, and/or otherwise processing data from one or more data source(s) 112.

In some embodiments, environmental data engine 104 may be configured to process data from one or more data source(s) 112 in order to provide environmental data to one or more information handling systems 102 and/or recommendation engine 108. For example, in the illustrative example of FIG. 1, environmental data engine 104 may be configured to analyze data from one or more sources of transportation, traffic, and/or social data. In such an example, environmental data engine 104 may be configured to determine a current state of traffic over a possible transportation route (e.g., whether a particular roadway is the scene of a delaying accident, heavily trafficked, etc.), a current state of a possible transportation route (e.g., whether a particular public transportation mode such as a subway line or bus is imminent or delayed), and/or whether other users of a possible transportation route are experiencing difficulties over that route (e.g., whether users report unusually high traffic, an accident that has not yet been reported, etc.). In other configurations of environmental data engine 104, data source(s) 112 may include data associated with weather, local events, and/or any other data appropriate for generating relevant environmental data. Environmental data engine 104 may be configured to analyze some, none, and/or all of these data source(s) in order to provide environmental data to one or more information handling systems 102 and/or recommendation engine 108 as described in more detail below.

In some embodiments, system 100 may also include context engine 106 configured to analyze data from one or more data source(s) 112 in order to provide context data to one or more information handling systems 102 and/or recommendation engine 108. For example, context engine 106 may be configured to access data from a plurality of data sources 112 corresponding to equipment data, event data, and/or location data.

In the example system 100 depicted in FIG. 1, context engine 106 may be communicatively coupled to three data sources 112. In some embodiments, context engine 106 may be communicatively coupled to more, fewer, and/or different data sources 112 than those illustrated in FIG. 1 without departing from the scope of the present disclosure.

Further, for ease of illustration, context engine 106 is depicted as communicatively coupled to separate data sources 112. In some embodiments, context engine 106 may be part of an integral information handling system along with one or more data source(s) 112 as well as other components of system 100 without departing from the scope of the present disclosure. In the same or alternative embodiments, one or more data source(s) 112 may be hosted remotely on one or more information handling system(s), hosted locally by one or more information handling system(s), and/or may be the result of aggregating, analyzing, compiling, and/or otherwise processing data from one or more data source(s) 112.

In some embodiments, context engine 106 may be configured to process data from one or more data source(s) 112 in order to provide context data to one or more information handling systems 102 and/or recommendation engine 108. For example, in the illustrative example of FIG. 1, context engine 106 may be configured to analyze data from one or more sources of equipment, event, and/or user data. In such an example, context engine 106 may be configured to determine a current state of information handling system 102 (e.g., whether it is in proper working order, has sufficient battery life, etc.), a current event requiring the attention of a user of information handling system 102 (e.g., a meeting, appointment, reminder, etc.), and/or a current status of a user of information handling system 102 (e.g., the user's location, identity, etc.). In other configurations of context engine 106, data source(s) 112 may include data associated with other tasks of information handling system 100, other events, and/or any other data appropriate for generating relevant context data. Context engine 106 may be configured to analyze some, none, and/or all of these data source(s) in order to provide context data to one or more information handling systems 102 and/or recommendation engine 108 as described in more detail below.

In some embodiments, system 100 may also include recommendation engine 108 configured to analyze data from one or more data source(s) 112 in order to provide recommendation data to one or more information handling systems 102 and/or notification engine 110. For example, recommendation engine 108 may be configured to access data from a plurality of data sources 112 corresponding to group data, transportation data, calendar data, and/or communication data.

In the example system 100 depicted in FIG. 1, recommendation engine 108 may be communicatively coupled to four data sources 112. In some embodiments, recommendation engine 108 may be communicatively coupled to more, fewer, and/or different data sources 112 than those illustrated in FIG. 1 without departing from the scope of the present disclosure.

Further, for ease of illustration, recommendation engine 108 is depicted as communicatively coupled to separate data sources 112. In some embodiments, recommendation engine 108 may be part of an integral information handling system along with one or more data source(s) 112 as well as other components of system 100 without departing from the scope of the present disclosure. In the same or alternative embodiments, one or more data source(s) 112 may be hosted remotely on one or more information handling system(s), hosted locally by one or more information handling system(s), and/or may be the result of aggregating, analyzing, compiling, and/or otherwise processing data from one or more data source(s) 112.

In some embodiments, recommendation engine 108 may be configured to process data from one or more data source(s) 112 in order to provide recommendation data to one or more information handling systems 102 and/or notification engine 110. For example, in the illustrative example of FIG. 1, recommendation engine 108 may be configured to analyze data from one or more sources of group, transportation, calendar, and/or communication data. In such an example, recommendation engine 108 may be configured to determine a current state of a potential future transportation route (e.g., traffic-related issues, possible alternative routes, public transportation options, etc.), a current state of one or more calendars (e.g., availability information of initiating user(s), availability of necessary participant(s), availability of optional participant(s), etc.), status of other users associated with an event (e.g., other users' current availability, relevant social data, etc.), and/or status of potential alternative communication mechanisms (e.g., a conference call line, web-based meeting software, etc.). In other configurations of recommendation engine 108, data source(s) 112 may include data associated with contexts of one or more additional information handling system(s) 102. Recommendation engine 108 may be configured to analyze some, none, and/or all of these data source(s) in order to provide recommendation data to one or more information handling system(s) 102 and/or notification engine 110 as described in more detail below.

In some embodiments, notification engine may be configured to provide notification of a context mismatch and/or recommendations for resolving the context mismatch to one or more information handling system(s) 102. For example, if a user of one information handling system 102 is going to miss a meeting due to the current context associated with that information handling system 102, notification engine 110 may notify other information handling systems 102 associated with an event of the context mismatch. In some configurations, this notification may include recommendations for future context resolutions.

In operation, the components of example system 100 may work together to provide realtime and/or near-realtime identification of a context mismatch. The following illustrative example is provided for a configuration of example system 100 in which the triggering event for identifying a context mismatch is a meeting between a plurality of users.

In one example, a group of users of a plurality of information handling systems 102 are collectively engaged via an event such as a meeting. In some configurations, at least some portion of the group of users may be scheduled to meet in person at a given date, time, and location. One such user may have an information handling system 102 communicatively coupled to context engine 106, environmental data engine 104, and/or recommendation engine 108.

In the illustrative example, context engine 106 may analyze data associated with the user, the user's information handling system 102, and the triggering event. For instance, context engine 106 may recognize that the event is upcoming (e.g., the meeting will begin in thirty minutes), that the user is a particular distance from the event's location (e.g., the meeting is fifteen miles away), and that the information handling system 102 is functioning properly.

Context engine 106 may communicate this data to information handling system 102, environmental data engine 104, and/or recommendation engine 108. In the illustrative example, environmental data engine 104 may analyze data associated with the user's environment. For instance, environmental data engine 104 may recognize that public transportation routes may be available (e.g., that the last train to get the user to the meeting location on time is leaving in five minutes), that traffic has overly congested certain transportation routes (e.g., certain public transportation routes are not running, certain roadways are seriously slowed, etc.), and/or that other users are reporting issues with a particular travel route (e.g., through social networking software, social media gathering, etc.).

Context engine 106 may communicate this data to information handling system 102, environmental data engine 104, and/or recommendation engine 108. In the illustrative example, recommendation engine 108 may analyze data from information handling system 102, context engine 106, and/or environmental data engine 104 in order to make an informed recommendation about how to handle potential changes to the triggering event.

In some embodiments, recommendation engine 108 may recognize from data received from context engine 106 (e.g., a “personal context”) and data received from environmental data engine 104 (e.g., an “environmental context”) that a context mismatch has occurred. Using the illustrative example described in more detail above, recommendation engine 108 may, for instance, recognize from data received from context engine 106 that the user of information handling system 102 has a meeting in thirty minutes that is fifteen miles away. Recommendation engine 108 may also recognize from data received from environmental data engine 104 that the user's normal transportation routes (e.g., public transportation, roadways, etc.) will likely not get the user to the event's location in time due to traffic or other issues.

In some embodiments, recommendation engine 108 may be configured to analyze other data sources 112 in order to make a recommendation to one or more information handling system(s) 102 regarding the impact of the context mismatch. Using the illustrative example described in more detail above, recommendation engine 108 may, for instance, analyze data associated with the calendars of other meeting attendees (e.g., required attendees, optional attendees, etc.), analyze data associated with predicted future transportation patterns (e.g., whether a particular traffic pattern is expected to clear quickly), the availability of other communication options (e.g., audio bridge line, video conference, etc.), and/or data associated with typical behavior and behavior patterns of other, similar context mismatches. For example, recommendation engine 108 may look at the calendars of the meeting attendees and determine that: (1) everyone is free at the same time tomorrow; (2) traffic is not expected to clear up, but public transportation is available; and (3) the user may only be a few minutes late even given the current context mismatch.

In some embodiments, recommendation engine 108 may be configured to present the user of information handling system 102 with options regarding how to handle the context mismatch. Using the illustrative example described in more detail above for instance, recommendation engine 108 may present the user with three options: (1) reschedule the meeting for the same time tomorrow; (2) notify meeting attendees that the user may be a few minutes late; or (3) notify meeting attendees that the user may be late and that an alternative communication medium (e.g., an audio bridge line) is to be used until the user's arrival. When a user selects his/her choice, recommendation engine 108 may be further configured to communicate data associated with that option to notification engine 110.

In some embodiments, notification engine 110 may be configured to notify some or all information handling systems 102 for which participation in the triggering event is important of the option selected by the user. Using the illustrative example described in more detail above for instance, notification engine 110 may send an automated message to the meeting attendees that the user may be late, that the meeting is to be rescheduled, and/or that an alternative communication medium is to be used.

Although specific communication routes, data types, and data values have been discussed for ease of illustration, one of ordinary skill in the art will appreciate that changes to some or all of these values may occur without departing from the scope of the present disclosure. For example, for ease of illustration, information handling system 102, environmental data engine 104, context engine 106, recommendation engine 108, and notification engine 110 are depicted as separate modules communicatively coupled to one another. In some embodiments, some or all of these components may be integrated into a single information handling system 102, and/or a plurality of information handling systems 102 communicatively coupled to one another. For example, a cellular telephone may be configured to host environmental data engine 104 and context engine 106, while recommendation engine 108 and/or notification engine 110 may be hosted remotely. In another example, a tablet computer may be configured to host environmental data engine 104, context engine 106, notification engine 110, and some portion of recommendation engine 108. Other portions of recommendation engine 108 may be hosted remotely. Other examples and configurations may be apparent to one of ordinary skill in the art without departing from the scope of the present disclosure.

Environmental data engine 104, context engine 106, recommendation engine 108, and notification engine 110 may be, in some embodiments, a software program stored on computer-readable media and executable by a processor of one or more information handling system(s) 102. Further, although environmental data engine 104, context engine 106, recommendation engine 108, and notification engine 110 are depicted as separate for ease of illustration, the functionality provided by these components may be performed by more, fewer, and/or different components. In addition, these components may, in a given configuration of system 100, be implemented as software, hardware, firmware, and/or any appropriate combination thereof. The components of example system 100 may be configured to provide realtime and/or near-realtime identification of a context mismatch. The components may also be a component or subroutine of a larger software program, such as the operating system, or hard-coded into computer-readable media, firmware stored on computer-readable media, and/or any hardware or software module configured to process data associated with the triggering event, including any necessary management functions.

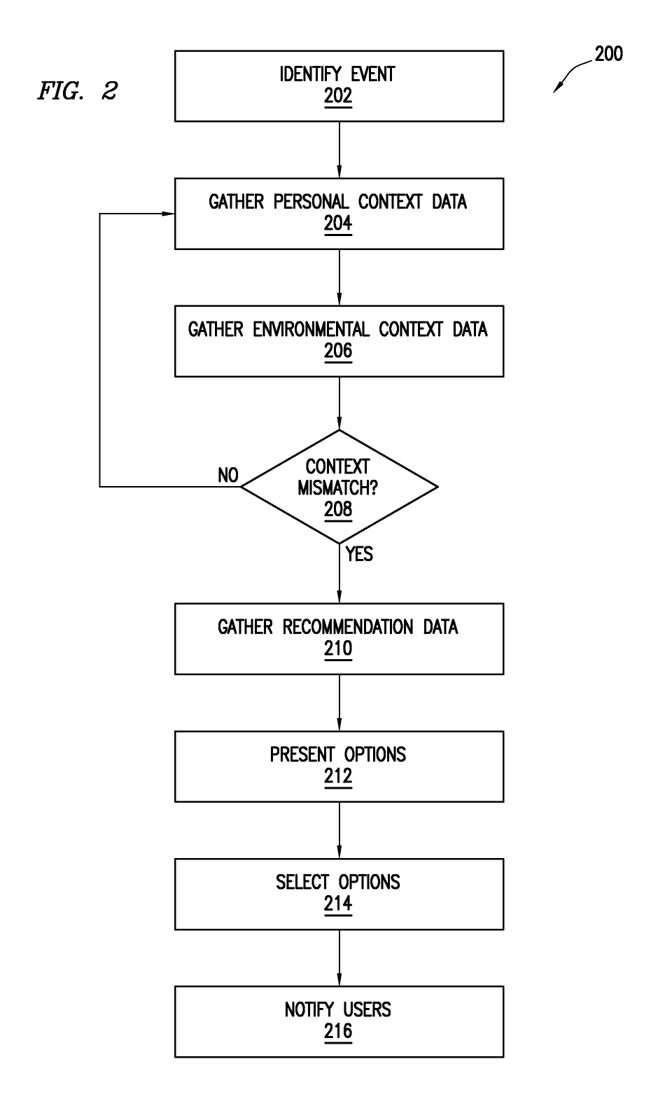

FIG. 2 illustrates a flowchart of an example method 200 for realtime and/or near-realtime identification of a context mismatch, in accordance with certain embodiments of the present disclosure. Method 200 may include gathering personal context data, gathering environmental context data, determining a context mismatch, and notifying all event users of mismatch management recommendations.

According to one embodiment, method 200 preferably begins at step 202. Teachings of the present disclosure may be implemented in a variety of configurations. As such, the preferred initialization point for method 200 and the order of steps 202-214 comprising method 200 may depend on the implementation chosen.

In some embodiments, the steps of method 200 may be performed by some or all of the components of system 100, as described in more detail above with reference to FIG. 1. For example, in some configurations, information handling system 102 may be responsible for determining whether a context mismatch exists. In other configurations, this determination may be performed by recommendation engine 108. In still other configurations, these steps may be performed by different components of system 100 with departing from the scope of the present disclosure.

At step 202, method 200 may identify a triggering event, as described in more detail above with reference to FIG. 1. For example, a plurality of users of a plurality of information handling systems 102 may initiate a meeting at which at least some of the users are to attend in person. As another example, a plurality of users of a plurality of information handling systems 102 may be part of a project plan for which at least some of the users' tasks are interdependent. After identifying the triggering event, method 200 may proceed to step 204.

At step 204, method 200 may gather personal context data, as described in more detail above with reference to FIG. 1. For example, context engine 106 may gather data associated with a user of information handling system 102 via one or more data source(s) 112. In the illustrative example in which the triggering event is a meeting, this data may include the time, topic, and location of the meeting, as well as the current time and location associated with information handling system 102. In the illustrative example in which the triggering event is a project, this data may include the current project plan, tasks assigned to a particular user, and the current status of information handling system 102. After gathering this data, method 200 may proceed to step 206.

At step 206, method 200 may gather environmental context data, as described in more detail above with reference to FIG. 1. For example, environmental data engine 104 may gather data associated with the environment associated with a user of an information handling system 102 via one or more data source(s) 112. In the illustrative example in which the triggering event is a meeting, this data may include the current status of certain public transportation routes, the current traffic status of certain roadway routes, and other data relevant to determining an environmental context associated with an information handling system 102 as it relates to the triggering event. In the illustrative example in which the triggering event is a project, this data may include the status of other information handling systems 102, the status of other projects sharing resources with the current projects, and other data relevant to determining an environmental context associated with an information handling system 102 as it relates to the triggering event. After gathering the environmental context data, method 200 may proceed to step 208.

At step 208, method 200 may determine whether a context mismatch exists, as described in more detail above with reference to FIG. 1. For example, recommendation engine 108 may determine whether data associated with a personal context indicates that it is inconsistent with an environmental context. In the illustrative example of a meeting, this may include determining whether existing traffic may prevent a user from attending a meeting, for instance. In the illustrative example of a project, this may include determining whether another project may take away resources at a key time, for instance. If no context mismatch exists, method 200 may return to step 204. If a context mismatch does exist, method 200 may proceed to step 210.

At step 210, method 200 may gather recommendation data, as described in more detail above with reference to FIG. 1. For example, recommendation engine 108 may gather data associated with determining a number of recommendations for how to resolve and/or manage an identified context mismatch. In the illustrative example of the meeting, this may include gathering data associated with the calendars of other attendees, availability of alternative communication mechanisms, social data on typical behavior, and/or transportation data in order to determine whether a meeting can be rescheduled, delayed, and/or managed through alternative means. In the illustrative example of a project, this may include gathering data associated with the task lists of other project team members and/or the availability constraints of other resources in order to determine whether a task can be pushed, restaffed, and/or managed through alternative means. Once recommendation data has been gathered, method 200 may proceed to step 212.

At step 212, method 200 may present one or more option(s) to the user of information handling system 102, as described in more detail above with reference to FIG. 1. For example, recommendation engine 108 may indicate to the user the various options associated with managing the context mismatch. In the illustrative example of the meeting, these may include rescheduling the meeting, notifying attendees of a possible delay, and/or implementing alternative communication mechanisms, for instance. In the illustrative example of the project, this may include notifying other project team members of a possible task delay, notifying the owners of other resources of a change in their usage status, and/or alternative management mechanisms, for instance. After presenting the options, method 200 may proceed to step 214, where the user may select the appropriate option. After selection, method 200 may proceed to step 216.

At step 216, method 200 may notify one or more user(s) of one or more information handling system(s) 102 of the option selected. In some embodiments, notification engine 110 may notify the user(s). For example, this may include an automated message indicating a change in the parameters of the triggering event, and/or requests to the users for additional input.

Although FIG. 2 discloses a particular number of steps to be taken with respect to method 200, method 200 may be executed with more or fewer steps than those depicted in FIG. 2. In addition, although FIG. 2 discloses a certain order of steps comprising method 200, the steps comprising method 200 may be completed in any suitable order. For example, in the embodiment of method 200 shown, the gathering of personal and environmental context data is shown as two separate, dependent steps. However, in some configurations, these two steps may be performed simultaneously and/or in phases.

What is claimed:

1. An information handling system for managing an event, the information handling system comprising:
an environmental data engine configured to gather an environmental context associated with a user of the event;
a context engine configured to gather a personal context associated with the user;
a recommendation engine configured to:
determine a context mismatch based at least on the environmental context and the personal context; and
generate a plurality of event management options for managing the context mismatch; and
a notification engine configured to notify a plurality of users of the event of a chosen option, the chosen option being one of the plurality of event management options.

2. The information handling system of claim 1, wherein the environmental context comprises data associated with transportation.

3. The information handling system of claim 1, wherein the recommendation engine is further configured to determine the context mismatch based at least on the environmental context, the personal context, and a recommendation context associated with the event.

4. The information handling system of claim 3, wherein the recommendation context comprises data associated with the plurality of users.

5. The information handling system of claim 3, wherein the chosen option comprises rescheduling the event.

6. The information handling system of claim 3, wherein the chosen option comprises an alternative communication mechanism.

7. The information handling system of claim 3, wherein the recommendation context comprises data associated with a typical behavior pattern.

8. An information handling system for managing an event, the information handling system comprising a recommendation engine configured to:
determine a context mismatch based at least on an environmental context and a personal context, wherein the environmental context and the personal context are associated with a first user of the event;
generate a plurality of event management options for managing the context mismatch;
present the plurality of event management options to the user; and
communicate a chosen option to a plurality of users of the event, the chosen option being one of the plurality of event management options.

9. The information handling system of claim 7, wherein the environmental context comprises data associated with transportation.

10. The information handling system of claim 7, wherein the recommendation engine is further configured to determine the context mismatch based at least on the environmental context, the personal context, and a recommendation context associated with the event.

11. The information handling system of claim 9, wherein the recommendation context comprises data associated with the plurality of users.

12. The information handling system of claim 9, wherein the chosen option comprises rescheduling the event.

13. The information handling system of claim 9, wherein the chosen option comprises an alternative communication mechanism.

14. The information handling system of claim 9, wherein the recommendation context comprises data associated with a typical behavior pattern.

15. A method for managing an event, the method comprising:
determining a context mismatch based at least on an environmental context and a personal context, wherein the environmental context and the personal context are associated with a first user of the event;
generating a plurality of event management options for managing the context mismatch;
presenting the plurality of event management options to the user; and
communicating a chosen option to a plurality of users of the event, the chosen option being one of the plurality of event management options.

16. The method of claim 14, wherein the environmental context comprises data associated with transportation.

17. The method of claim 14, wherein determining the context mismatch comprises determining the context mismatch based at least on the environmental context, the personal context, and a recommendation context associated with the event.

18. The method of claim 16, wherein the recommendation context comprises data associated with the plurality of users.

19. The method of claim 16, wherein the chosen option comprises rescheduling the event.

20. The method of claim 16, wherein the chosen option comprises an alternative communication mechanism.

21. The method of claim 16, wherein the recommendation context comprises data associated with a typical behavior pattern.
